(19) United States
(12) Patent Application Publication
(10) Pub. No.: US 2012/0156488 A1
(43) Pub. Date: Jun. 21, 2012

(54) Thermoplastic Composite Tension Member And Method Of Manufacturing To Be Used As Sailboat Rigging

(76) Inventors: Mike J. Curtin, Norwalk, CT (US); Chris S. Funke, JR., West Haven, CT (US)

(21) Appl. No.: 13/164,659

(22) Filed: Jun. 20, 2011

Related U.S. Application Data
(60) Provisional application No. 61/356,992, filed on Jun. 21, 2010.

(51) Int. Cl. D02G 3/00; B32B 38/00; B32B 38/04; B32B 37/14

(52) U.S. Cl. 428/397; 156/60; 156/184; 156/252

(57) ABSTRACT

Shaped terminations for composite tension members, as well as methods for creating such shaped terminations. A shaped termination is consolidated into a solid mass that is substantially uniform in structure. Heat and pressure are used to shape and fuse the carbon fiber composite into geometries having favorable loading characteristics. This durably fixes the components of the tension member into an optimized arrangement for the intended loading configuration such that unequal stresses are minimized. Terminal geometry can be formed by re-forming existing material, or by adding additional material, which can comprise a thermoplastic composite material or other epoxy/resin composite, metal, tow, tape, mat, or other fibers, to the inside or outside of the tension member. The terminal may be machined and/or thermoformed before and/or after the addition of material.

### CROSS-REFERENCE TO RELATED APPLICATIONS

This application claims priority pursuant to 35 U.S.C. §119(e) and 37 CFR §1.78(a)(4), to provisional Application No. 61/356,992, filed Jun. 21, 2010, the content of which is incorporated herein by reference.

### FIELD OF THE INVENTION

The invention relates to shaped terminations for composite tension members, as well as methods for creating such shaped terminations.

### BACKGROUND OF THE INVENTION

The leisure marine industry relies upon strong and lightweight tension members for a number of applications, including various types of rigging for sailboats. High-performance sailboats can benefit greatly from the use of tension members that combine high tensile strength, high modulus, resistance to corrosive salt-water environments, light weight, durability, and reduced cross section. However, optimization of these features can involve significant trade-offs, particularly between those affecting light weight and cross section vs. durability.

Carbon fiber based tension members offer an attractive combination of the qualities listed above; however they suffer from the inefficiencies common to many fiber-based tension members including a vulnerability to unequal loading of the component fibers. In applications where the fiber bundle is loaded such that the majority of the load is applied only to a subset of the component fibers, the overall tensile strength of the member is reduced, and an immediate or gradual cascading failure of the fibers can result.

In general, where a consolidated grouping of fibers is bent while under tension, the fibers on the outside of the bend will bear an increasing share of the load, while the innermost fibers will slacken. The application of carbon fiber tension members to sailboat rigging can create regions that are particularly susceptible to uneven loading of the component fibers. Rigging generally also ends in a terminal of some type, in addition to applications where rigging is bent continuously around a structure such as a mast. These terminals, if not thoughtfully designed, may incorporate bends, loops, or knots that result in unequal fiber loading. Accordingly, there have been a number of attempts to address this problem.

A known terminal system for composite tension members is disclosed in U.S. Pat. No. 7,137,617 (Sjostedt). It includes a tension cable comprising a plurality of composite rods bundled together into a composite cable. The ends of this composite cable are splayed out and embedded into a fitting having an internal cavity that flares outwardly, where they are held by adhesives and/or in an interference fit using wedges or plugs adapted to fit the internal cavity of the fitting. However, the anchoring strength of the splayed material is dependent upon the bonding and frictional forces provided by the wedges and/or adhesives. When the included angle of the internal cavity flare is low, the tension member is subject to pulling out if the tensile forces exceed the friction imparted by the wedging forces and/or adhesive. If the included angle of the internal cavity flare is high, excessive stress can be concentrated upon individual components of the splayed material at the angle, increasing the likelihood of successive individual component breakage, and premature failure of the tension member.

Another system for terminating tension members is disclosed in U.S. Pat. No. 3,660,887 (Davis). It includes a tension cable comprising a plurality of fibers. The ends of this cable are spread within a fitting having an internal cavity, and a potting compound is cast in place within the fitting in order to surround the cable with a closely conforming complimentary surface. However, like U.S. Pat. No. 7,137,617, the spread fibers are subject to pull-through and excessive individual stresses.

What is desired therefore is a composite tension member having a terminal with characteristics that address these deficiencies.

### SUMMARY OF THE INVENTION

It is an object of the invention to provide a shaped terminal to a composite tension member. Ideally, this shaped terminal will be consolidated into a solid mass that is substantially uniform in structure. This arrangement has the advantage of ensuring that the components of the tension member at the terminal are durably fixed into an optimized arrangement for the intended loading configuration, such that unequal stresses are minimized.

Tension members may comprise a thermoplastic rod or bundle of rods comprising a thermoplastic resin and a high strength and high modulus carbon fiber or other fiber.

Objects of the invention are achieved by forming a terminal using heat and pressure to shape and fuse the carbon fiber composite into geometries having favorable loading characteristics. The forming of the terminal geometry can be completed by re-forming existing material, or by adding additional material, which can be the same thermoplastic, epoxy or other resin/fiber composite material in the form of tow, tape material, mat or bulk; to the inside, outside, or throughout the tension member. The fill of the epoxy or thermoplastic can be nano-fibers, chopped fibers, unidirectional fibers, or other fibers. The terminal may be machined and/or thermoformed before and/or after the addition of material.

Terminal geometries can include, but are not limited to: frustum, concave head, convex spherical head, conical taper, eye (e.g. material wrapped around pin and fused back onto itself), threaded (male and female), overlap joint, unidirectional tube overlap joint, laminate, flatten-and-overlap, two-into-one (butt-joint, diagonals onto verticals) and so forth.

The invention and its particular features and advantages will become more apparent from the following detailed description considered with reference to the accompanying drawings.

### BRIEF DESCRIPTION OF THE DRAWINGS

FIG. 1 is an overview of the tension member showing the shaped terminal.

FIG. 2 is a section view of a shaped terminal, showing its consolidated structure.

FIG. 3 is a section view of an unconsolidated portion of a tension member, showing its unconsolidated structure.

FIG. 4 is a flow chart illustrating a method for creating a consolidated shaped terminal according to a preferred embodiment of the invention.

FIG. 5 is a section view of a die used in the consolidation of tension members.

FIG. 6 is a view of the die shown in an arrangement where it may be transported to different regions of a tension member.

FIG. 7 is a section view of the arrangement of the die as in FIG. 6.

FIG. 8 is a view of a consolidated end of a tension member that may result from the action of the die according to various embodiments of the invention.

FIG. 9 is a view of a drilled consolidated end of a tension member that has been drilled axially according to various embodiments of the invention.

FIG. 10 is a section view of a splitting die that may be used to split the drilled consolidated end of a tension member according to various embodiments of the invention.

FIG. 11 is a view of a split end of a tension member that may result from use of the splitting die of FIG. 10.

FIGS. 12a-c are section views illustrating the steps of inserting materials into a void created in the end of a tension member according to various embodiments of the invention.

FIG. 13 is a view of a consolidated shaped terminal according to embodiments of the invention.

FIG. 14 is a flow chart illustrating a method for creating a consolidated shaped terminal according to an alternative embodiment of the invention.

FIGS. 15a-e are section views illustrating the creation of a void and insertion of materials into the end of a tension member according to an alternative embodiment of the invention.

FIGS. 16a-d are section views illustrating the insertion of a material part into the end of a tension member according to an alternative embodiment of the invention.

FIG. 17 is a flow chart illustrating a method for creating a consolidated shaped terminal according to an alternative embodiment of the invention.

FIG. 18 is a section view of an arrangement of a tension member and a collar piece for surrounding the end of the tension member according to an alternative embodiment of the invention.

FIGS. 19a-d are section views of various bends and joins of tension members according to an alternative embodiment of the invention.

FIGS. 20a-c are section views of the formation of a shaped terminal using two coordinating dies according to an alternative embodiment of the invention.

FIG. 21 is a section view of an application of a shaped terminal where the terminal is connected to a fitting.

FIGS. 22a-h are section views of example geometries into which shaped terminals may be formed, and corresponding collar shapes which may be used in order to create the geometries.

FIGS. 23a-c illustrate an arrangement for creating a shaped terminal by adding material prior to initial consolidation according to an alternative embodiment of the invention.

### DETAILED DESCRIPTION OF THE INVENTION

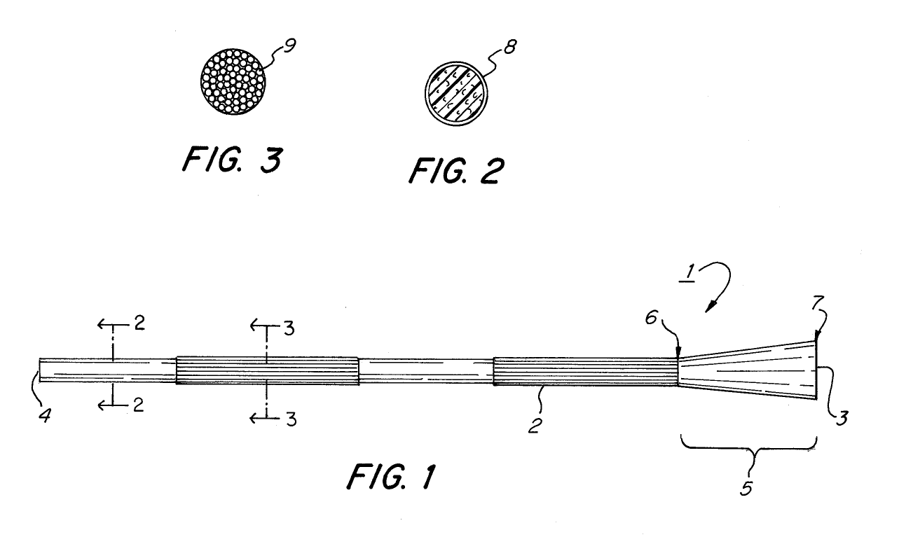

FIG. 1 illustrates an overview of a tension member 1, which may be elongated in shape. Tension member 1 comprises a plurality of composite rods, fibers, tow, or tape arranged to form a bundle 2. Bundle 2 comprises a first end 3 and a second end 4. The composite rods 2 may comprise a thermoplastic resin and high strength and/or high modulus carbon fibers or other fibers. A shaped terminal 5 is formed at first end 3. Shaped terminal 5 may be consolidated such that its composition is solid and substantially unified in structure. Shaped terminal 5 comprises an inner end 6 that is disposed toward the center of tension member 1, and an outer end 7 that is disposed toward, or substantially coincident with, first end 3. Outer end 7 may have a dimension that is greater than a corresponding dimension of the inner end 6.

In all figures and embodiments, second end 4 can be formed into a consolidated shaped terminal (not shown) in the same manner as described for first end 3.

FIG. 2 illustrates a cross-section 8 of a shaped terminal, showing its consolidated structure. FIG. 3 illustrates a cross-section 9 of an unconsolidated portion of a tension member, showing its unconsolidated structure.

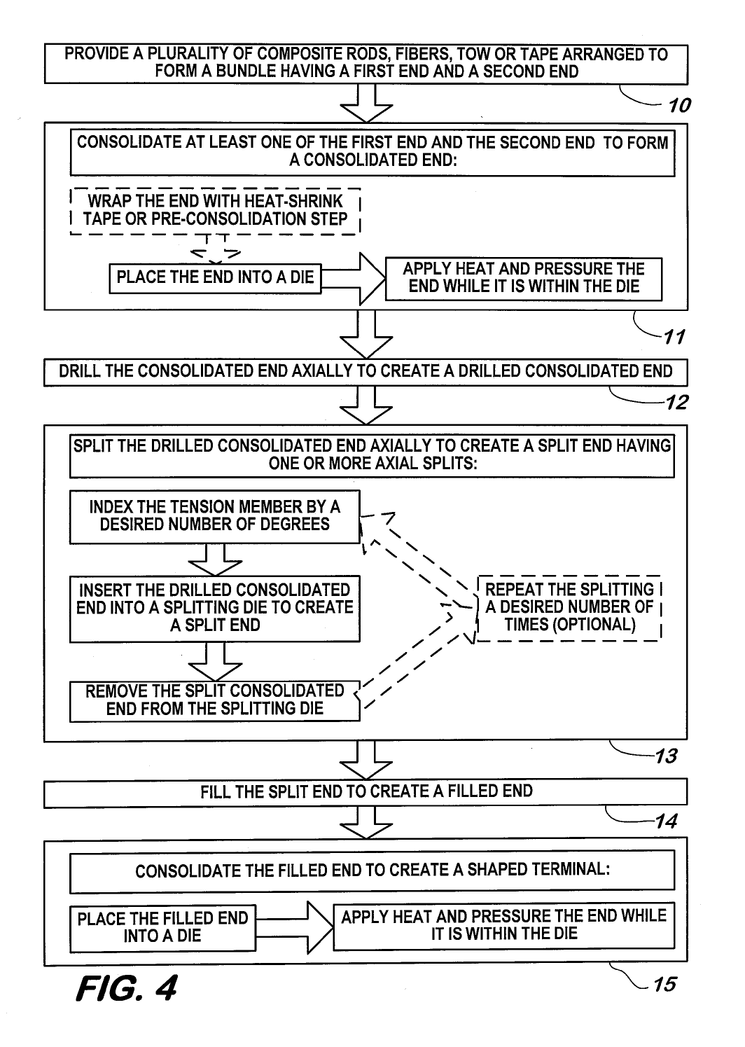

FIG. 4 illustrates a preferred embodiment of the invention describing a method of creating a consolidated shaped terminal to a composite tension member. In a first step 10, a plurality of composite rods, fibers, tow or tape are first arranged to form a bundle having a first end and a second end. In second step 11, the first end is consolidated by placing it into a die and applying heat and pressure to the end while it is within the die to create a consolidated end comprising a unified structure. In an alternate embodiment, the first end is consolidated by wrapping it with a heat-shrink tape prior to placement within the die. In another alternate embodiment, an initial pre-consolidation is applied to the first end where it is compressed and reformed using heat and pressure such that an exterior profile of the bundle is given a smaller cross-section and/or a desired shape, and such that at least some interstitial spaces between the resin/fiber composite rods, fibers, tow or tape are removed or reduced; In third step 12, the first end is drilled axially to create a drilled consolidated end, having an axial drill hole disposed therein. In fourth step 13, the drilled, consolidated end is split axially to create a split end by indexing the tension member by a desired number of degrees around its axis, inserting the drilled consolidated end into a splitting die, and optionally, repeating the splitting a desired number of times. In a fifth step, 14, the split end is filled to create a filled end by adding thermoplastic and/or composite material to the void that was created by drilling and splitting. In a sixth step, 15, the filled end is consolidated by placing the filled end into an appropriately shaped die; and applying heat and pressure to the end while it is within the die to create a shaped terminal that is consolidated and unified in structure, and where the shaped terminal has an outer end disposed at the end of the tension member; an inner end disposed toward the center of the tension member; and where the outer end of the shaped terminal has a dimension that is greater than a corresponding dimension of the inner end of the shaped terminal.

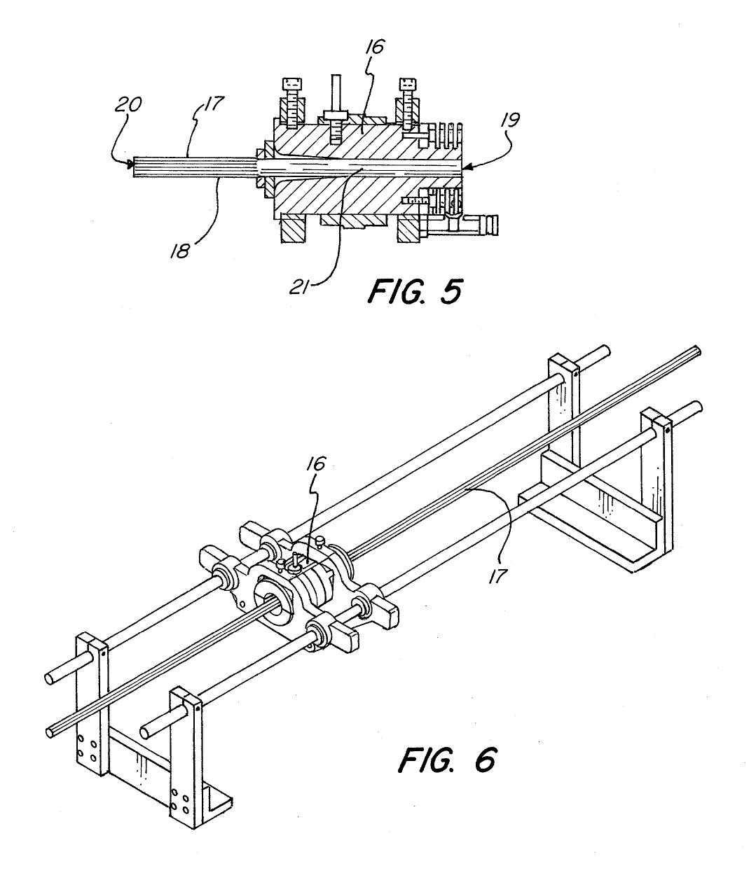

FIG. 5 illustrates a die 16 to be used in a consolidation step of the preferred embodiment in order to form a consolidated end (not shown). Die 16 is adapted to accept a plurality of composite rods, fibers, tow, or tape that may comprise a thermoplastic resin and high strength and/or high modulus carbon fibers or other fibers and is arranged to form a bundle 17 having a central portion 18, a first end 19, and a second end 20. Die 16 may be used to create consolidated regions 21 in portions of bundle 17 which have a substantially unified structure, including the first end 19, second end 20, sub-portions of, or the entirety of, central portion 18, by applying heat and pressure to the portion as it is held within die 16.

FIG. 6 illustrates the arrangement of the die 16 such that it may be transported to different regions of bundle 17 in order to create consolidated regions. In an alternate embodiment, die 16 may be transported along the regions of bundle 17 while applying continuous heat and pressure in order to form a continuous consolidated region of arbitrary length (not shown). In alternate embodiments, die 16 may be held fixed to the center axis of bundle 17, or may rotate around the centerline axis of bundle 17 during all or part of the consolidation process.

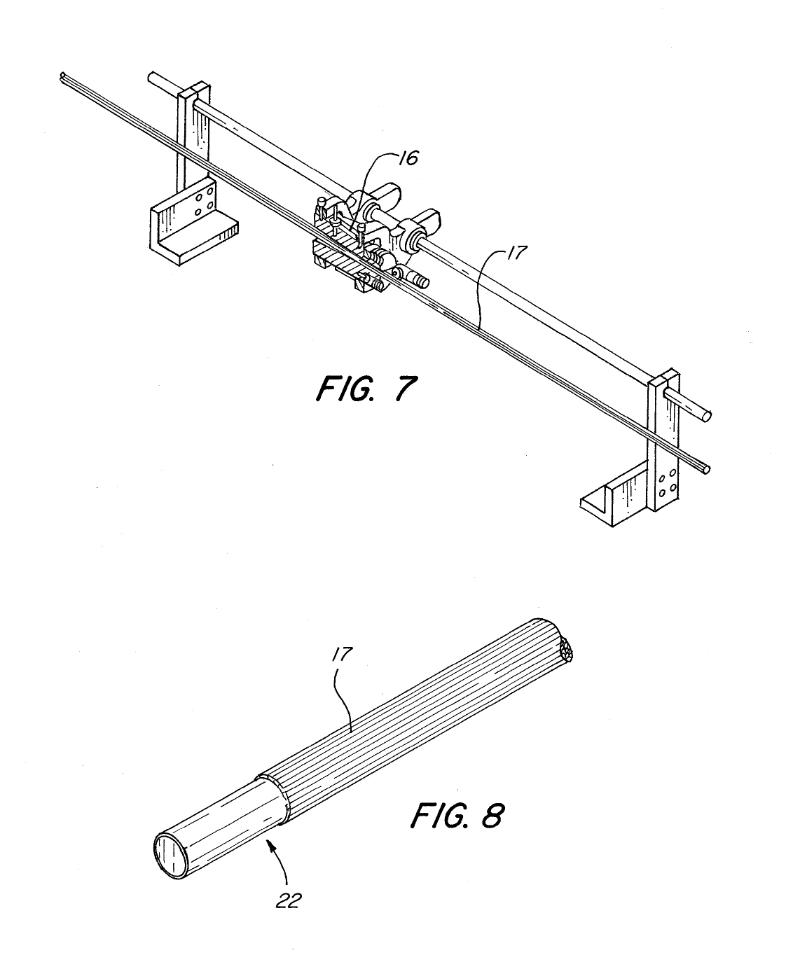

FIG. 7 illustrates a section view of the arrangement of the die 16 with respect to bundle 17.

FIG. 8 illustrates a resulting consolidated end 22 of the bundle 17 which has been consolidated by the action of a die (not shown) as described with respect to FIGS. 5-7 and FIG. 4 (11).

FIG. 9 illustrates a drilled consolidated end 23 of bundle 17, showing axial drill hole 24, such as may result from axial drilling as described with respect to FIG. 4 (12).

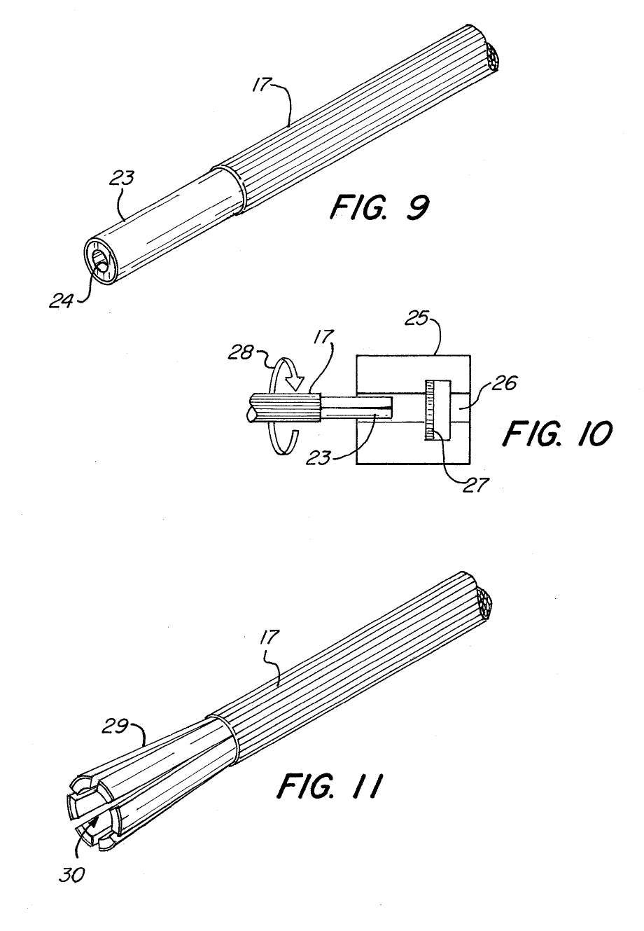

FIG. 10 illustrates a splitting die 25 which can be used to split the drilled consolidated end 23 of tension member 17, as described with respect to FIG. 4 (13). Splitting die 25 comprises a channel 26 adapted to accept drilled consolidated end 23, and blade 27. A suitable wedge, saw, or other splitting or slicing means known in the art may be used in place of blade 27. Blade 27 intersects with channel 26 and is adapted and disposed such as to split drilled consolidated end 23. Bundle 17 is first indexed by a desired number of degrees about its primary axis as shown by arrow 28. Drilled consolidated end 23 is then inserted into the channel 26 to a desired depth and using a desired force such that drilled consolidated end 23 is split to a desired extent by the blade 27. The resulting split end (not shown) is then removed from channel 26, and can optionally be indexed and split one or more subsequent times to create additional discrete splits.

FIG. 11 illustrates a portion of bundle 17 and split end 29 of previously consolidated end of bundle 17 which has resulted from the action of the splitting die (not shown) as described with respect to FIG. 10 and FIG. 4 (13), showing a void 30 that has been created in split end 29.

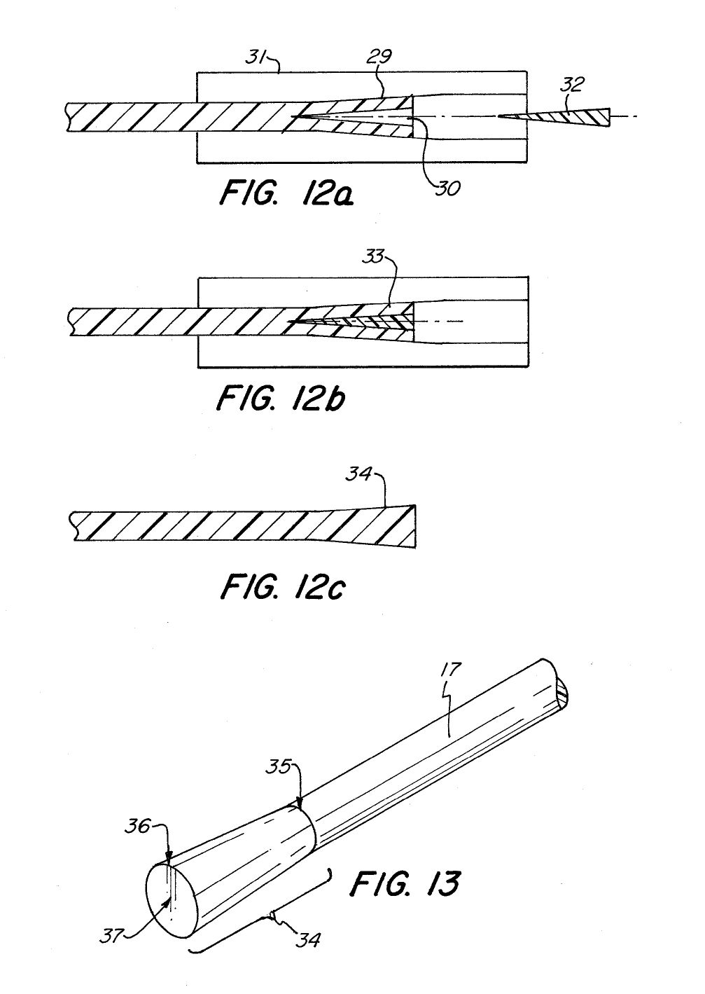

FIG. 12a illustrates a die 31 adapted to accept the split end 29 which is described with respect to FIG. 11. First, split end 29 is placed within die 31. Material 32, which may be thermoplastic resin and/or composite material, is then inserted into void 30 of split end 29 to create a filled end (not shown). In alternative embodiments, the material 32 can comprise a metal or metal alloy, or other suitable material.

FIG. 12b illustrates a filled end 33 which is created as described with respect to FIG. 12a and FIG. 4 (14). Heat and pressure are applied to filled end 33 as it is held within a die to create a consolidated shaped terminal (not shown).

FIG. 12c illustrates a consolidated shaped terminal 34 created as described with respect to FIG. 12b and FIG. 4 (15).

FIG. 13 further illustrates a consolidated shaped terminal 34 created as described with respect to FIG. 12b and FIG. 4 (15). Shaped terminal 34 is consolidated such that its composition is solid and substantially unified in structure, and comprises an inner end 35 that is disposed toward the center of bundle 17, and an outer end 36 that is disposed toward, or substantially coincident with, tension member end 37. Outer end 36 may have a dimension that is greater than a corresponding dimension of the inner end 35.

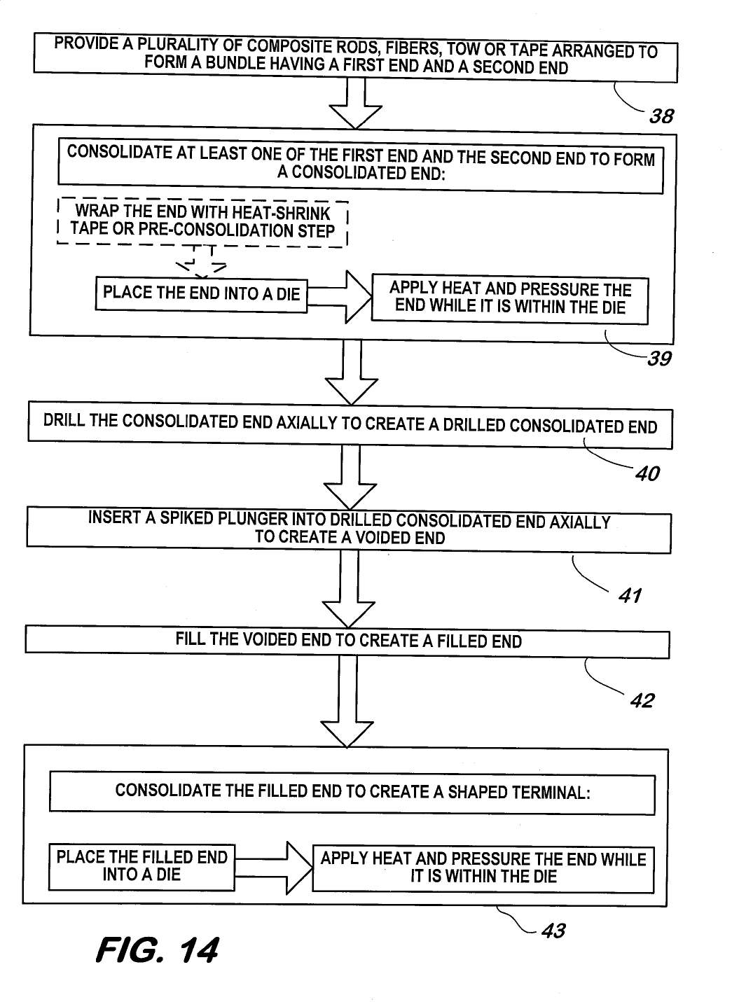

FIG. 14 illustrates an alternative embodiment of the invention, describing a method of creating a consolidated shaped terminal to a composite tension member. This embodiment is similar to the preferred embodiment described above with respect to FIG. 4, except in that the creation of a void in a drilled consolidated end of a tension member is achieved using a spiked plunger step 41 rather than by the splitting step of the preferred embodiment that is described with respect to FIG. 4 (13).

Here, in a first step 38, a plurality of composite rods, fibers, tow or tape are first arranged to form a bundle having a first end and a second end. In second step 39, the first end is consolidated by placing it into a die and applying heat and pressure to the end while it is within the die to create a consolidated end comprising a substantially unified structure. In an alternate embodiment, the first end is consolidated by wrapping it with a heat-shrink tape prior to placement within the die. In another alternate embodiment, an initial pre-consolidation is applied to the first end where it is compressed and reformed using heat and pressure such that an exterior profile of the bundle is given a smaller cross-section and/or a desired shape, and such that at least some interstitial spaces between the resin/fiber composite rods, fibers, tow or tape are removed or reduced; In other alternative embodiments, the die may also be transported along the length of the bundle to form continuous consolidated regions of arbitrary length, as in the preferred embodiment. In third step 40, the consolidated end is drilled axially to create a drilled consolidated end.

In fourth step 41, a spiked plunger is inserted into the drilled, consolidated end axially to create a voided end having a void by applying heat and pressure. Here, the drill hole may serve as a pilot hole for insertion of the spiked plunger.

In a fifth step, 42, the voided end of the previously consolidated end of the bundle is filled to create a filled end by adding thermoplastic and/or composite material to the void that was created by drilling and plunging. In an alternative embodiment, the material added to the void can comprise a metal or metal alloy, or other suitable material. In a sixth step, 43, the filled end is consolidated by placing the filled end into an appropriately shaped die; and applying heat and pressure to the end while it is within the die to create a shaped terminal that is consolidated and substantially unified in structure, and where the shaped terminal has an outer end disposed toward, or substantially coincident with, the end of the tension member; an inner end disposed toward the center of the tension member; and where the outer end of the shaped terminal has a dimension that is greater than a corresponding dimension of the inner end of the shaped terminal.

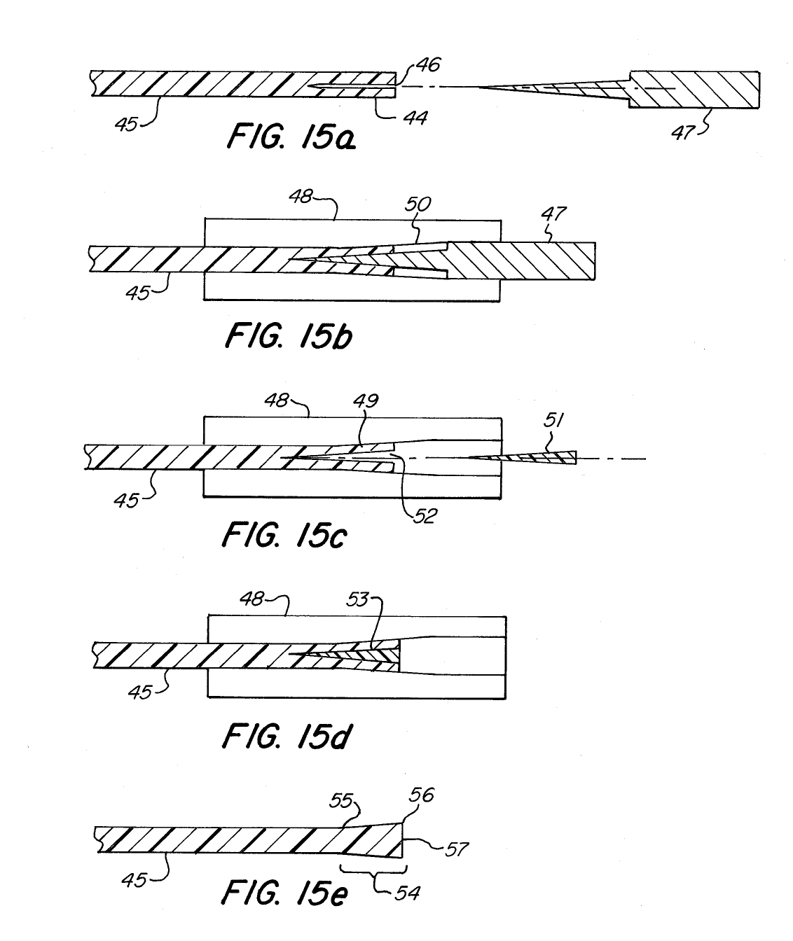

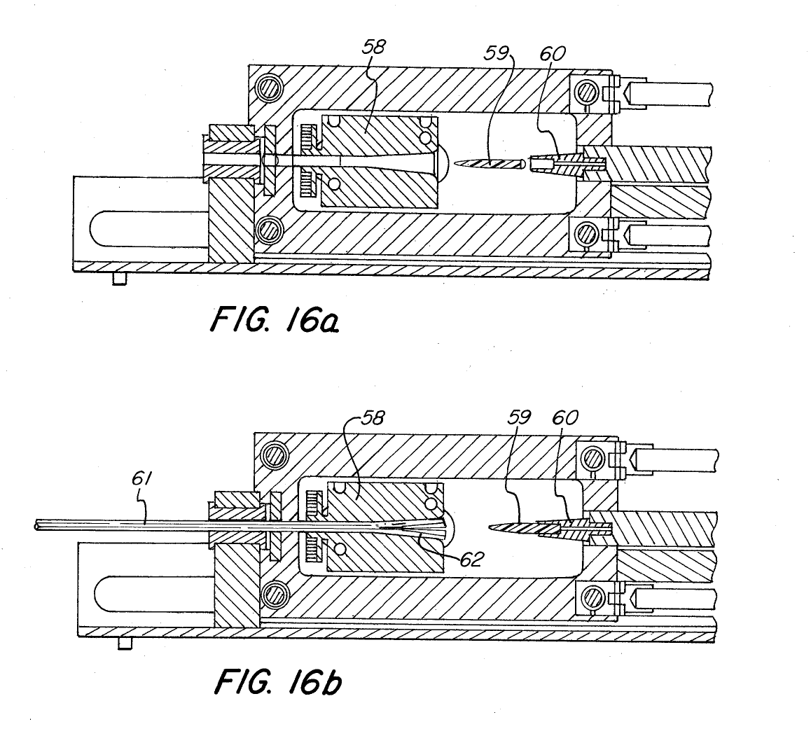

FIGS. 15a-e illustrate the alternative embodiment of the invention, wherein a void is created in a drilled consolidated end of a tension member using a spiked plunger.

FIG. 15a illustrates a drilled consolidated end 44 of a tension member 45 showing drill hole 46. Drill hole 46 may serve as a pilot hole for the insertion of a spiked plunger 47. Spiked plunger 47 is aligned axially with drilled consolidated end 44 such that it may be plunged axially into drilled consolidated end 44 in order to create a void (not shown).

FIG. 15b illustrates the end 50 of the tension member 45 which is held within a die 48. Spiked plunger 47 has been plunged axially into the end 50 of the tension member such that upon removal, a void (not shown) will have been created in the drilled consolidated end (shown in FIG. 14a 44), creating a voided end (not shown).

FIG. 15c illustrates a voided end 49 of the tension member 45 which is held within die 48. A plunger has previously been applied to the drilled consolidated end (not shown) as described with respect to FIG. 14b in order to create voided end 49. Material 51 is shown in preparation for insertion into void 52 of voided end to create a filled end (not shown). In various embodiments, Material 51 comprises one or more of a thermoplastic and/or composite material, a metal or metal alloy, or other suitable material.

FIG. 15d illustrates a filled end 53 of a tension member which is held within die 48. A material has previously been inserted into a voided end as described with respect to FIG. 14c in order to create filled end 53. Heat and pressure are applied to filled end while it is held within die in order to create a shaped terminal (not shown).

FIG. 15e illustrates a shaped terminal 54 to a tension member which was created as described with respect to FIG. 14d. Shaped terminal 54 is consolidated such that its composition is unified in structure, and comprises an inner end 55 that is disposed toward the center of tension member 45, and an outer end 56 that is disposed toward, or coincident with, tension member end 57. Outer end 56 may have a dimension that is greater than a corresponding dimension of the inner end 55.

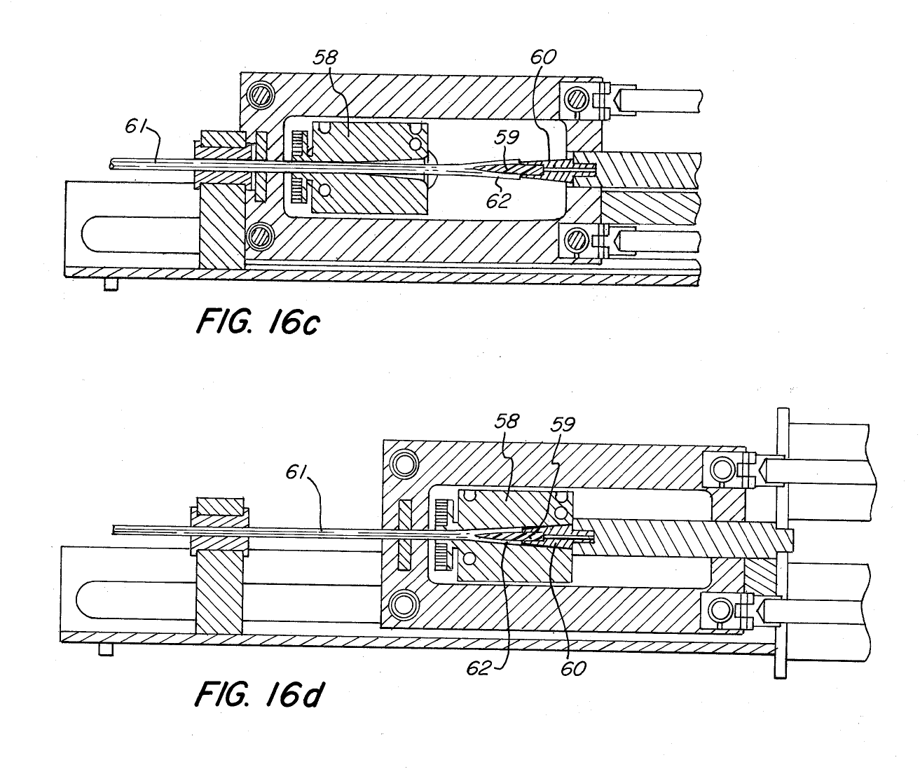

FIGS. 16a-d illustrate an alternative embodiment of the invention wherein a preformed material is plunged axially into the tension member. This arrangement, or any portions of this arrangement, may be used in combination with any of the embodiments described herein to replace or compliment steps for adding material to the tension member end.

FIG. 16a illustrates the arrangement of a die 58, a material 59, which may have a spiked shape and in various embodiments may comprise one or more of a thermoplastic and/or composite material, a metal or metal alloy, or other suitable material, and a plunging arm 60, which is adapted to position material 59. FIG. 16b illustrates the arrangement of the die 58, material 59, and plunging arm 60. A tension member 61 having a tension member end 62, which has been prepared in advance of this step to create a void using methods such as those described with respect to FIG. 4 or 14, or by using other methods known in the art, is disposed within the die 58, and the material 59 is disposed within the plunging arm 60, in preparation for insertion of the material 59 into tension member end 62. FIG. 16c shows the arrangement of the die 58, material 59, plunging arm 60, and tension member 61, where the tension member 61 has been advanced through the die 58 in order to contact the material 59 axially, in preparation for insertion. FIG. 16d shows the arrangement of the die 58, material 59, plunging arm 60, and tension member 61, where the die 58 has been advanced over the tension member end 62 to create a press fit between the material 59 and the tension member end 62. Heat and pressure may be applied at this stage or a subsequent stage to incorporate material into tension member end 62 in order to create a shaped terminal having a consolidated structure (not shown).

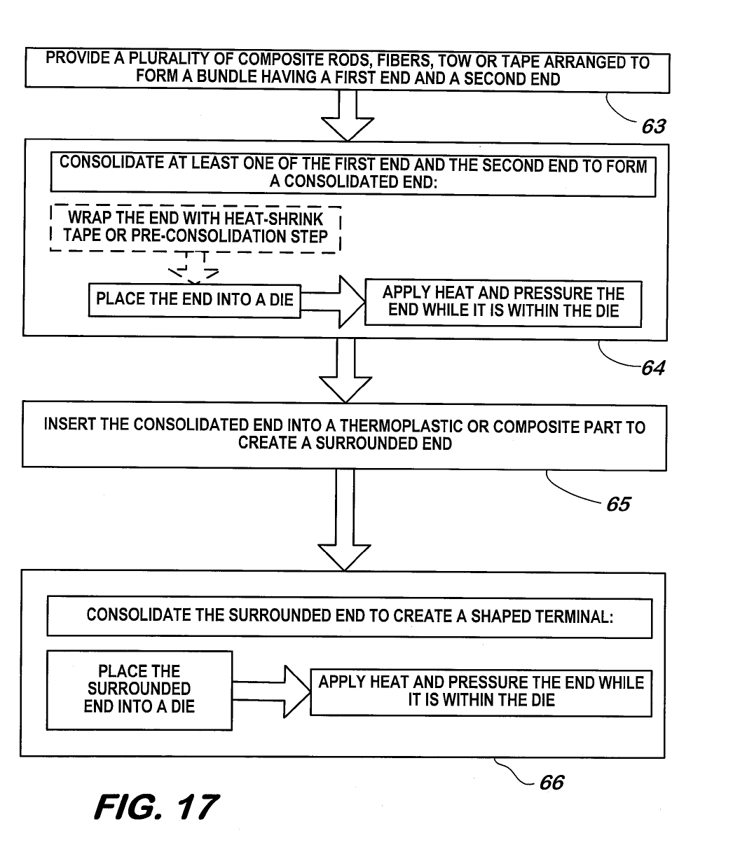

FIG. 17 illustrates an alternative embodiment of the invention which includes adding material to the outside of the tension member end. This embodiment is similar to the preferred embodiment described above with respect to FIG. 4, except in that the addition of composite or thermoplastic material to the consolidated end of a tension member is achieved by using an insertion step 65 rather than by using the drilling, splitting, and filling steps of the preferred embodiment that are described with respect to FIG. 4 (12, 13, 14). This arrangement, or any portions of this arrangement, may be used in combination with any of the embodiments described herein to replace or compliment steps for adding material to the tension member end.

Here, in a first step 63, a plurality of composite rods, fibers, tow or tape are first arranged to form a bundle having a first end and a second end. In second step 64, the first end is consolidated by placing it into a die and applying heat and pressure to the end while it is within the die to create a consolidated end comprising a unified structure. In an alternate embodiment, the first end is consolidated by wrapping it with a heat-shrink tape, and applying heat to the end while it is wrapped with the heat-shrink tape.

In third step 65, the consolidated end is inserted into a thermoplastic or composite part having the shape of a collar or other shape such that the material surrounds the consolidated end to create a surrounded end.

In fourth step 66, the surrounded end is consolidated by placing the surrounded end into an appropriately shaped die; and applying heat and pressure to the end while it is within the die to create a shaped terminal that is consolidated and substantially unified in structure, and where the shaped terminal has an outer end disposed toward, or substantially coincident with, the end of the tension member; an inner end disposed toward the center of the tension member; and where the outer end of the shaped terminal has a dimension that is greater than a corresponding dimension of the inner end of the shaped terminal.

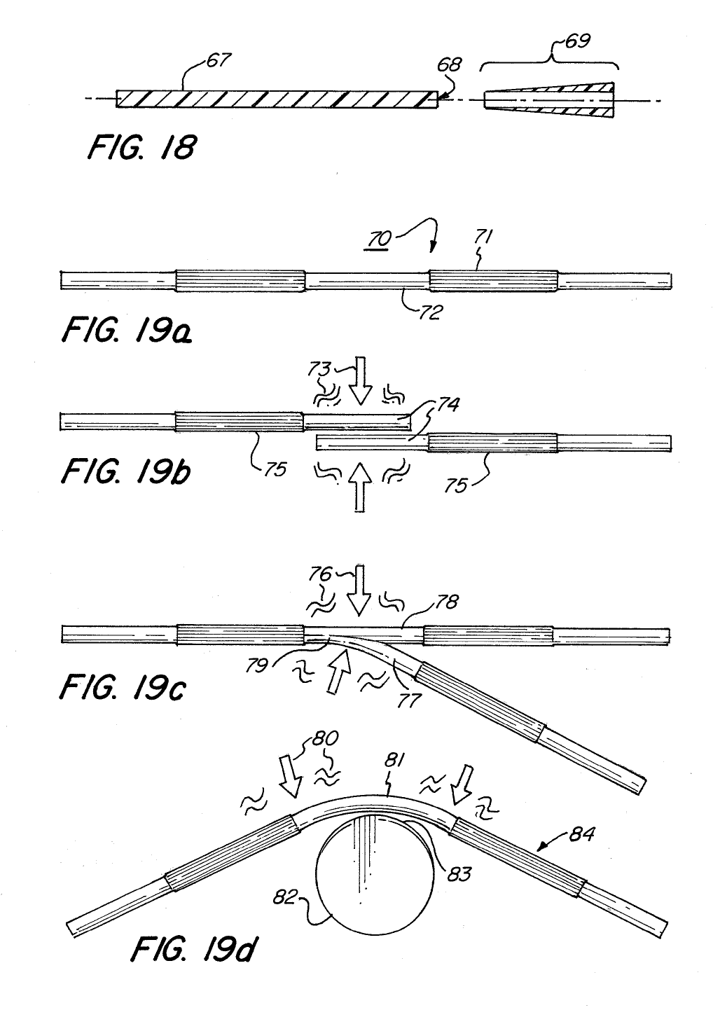

FIG. 18 illustrates the step of the alternative embodiment of the invention which includes adding material to the outside of the tension member end that is described with respect to FIG. 16 (65). Here, a tension member 67, tension member end 68, and material sleeve 69, that is comprised of a thermoplastic or composite material, are shown.

FIGS. 19a-f illustrate further embodiments of the invention wherein the consolidation techniques described herein are applied to other sections of the tension member, or to multiple tension members.

FIG. 19a illustrates a tension member 70 comprising a bundle 71 of thermoplastic or composite rods, fibers, tape, or tow, that has been consolidated in one or more mid-span portions 72 by the application of heat and pressure using a die (not shown) as described with respect to FIGS. 5-7.

Because a bundle of individual, small-diameter thermoplastic rods is more flexible than a comparatively large-diameter solid thermoplastic rod; in some embodiments, one or more mid-span lengths of tension member 1 can be left as individual, separate thermoplastic rods, while other mid-span lengths are consolidated. This has the advantage of providing one or more bending locations to coil the entire assembly for shipping, storage, or other purposes. In alternate embodiments, heat and pressure can be applied to sections of the bundle, using a die or heat-shrink tape as developed above, using a degree of heat and/or pressure that is lower than that used to fuse and consolidate the bundle. The temperature and/or pressure used are selected such that the thermoplastic rod components of the bundle are not fused. Rather, the components are caused to deform to a degree such that the exterior profile of the tension member is given a smaller cross-section and/or a desired shape, and such that some, or all interstitial spaces between the components are removed. This is performed in such a way that the components of the tension member retain their independent movement and remain under equal tension. This can have the combined advantage of providing a section that is flexible for bending as above, but also exhibits desirable drag and windage characteristics.

FIG. 19b illustrates the use of heat and pressure 73 to join consolidated end portions 74 of two separate tension members 75 such that the joint comprises a consolidated and substantially unified structure.

FIG. 19c illustrates the use of heat and pressure 76 to join the consolidated end portion 77 of one tension member to the consolidated mid-span portion 78 of a separate tension member such that the joint 79 comprises a consolidated and substantially unified structure.

FIG. 19d illustrates the use of heat and pressure 80 to bend an unconsolidated mid-span portion of a tension member 84, having components under equal tension, around a form 82 having a radiused surface 83. This method creates a radiused mid-span portion 81 comprising a consolidated and substantially unified structure. In alternative embodiments, heat and pressure 80 is applied using methods developed herein incorporating a die (not shown) or using heat-shrink tape (not shown). By forming a radiused mid-span portion 81 in this way, the resulting tension member 84 can be fastened around similarly radiused objects such as mast spreader bends with a reduction or substantial elimination of weakening due to imbalanced loading of the composite structure of the tension member at the site of the radius. This can have the advantage of increasing the tensile strength of a tension member used for such applications.

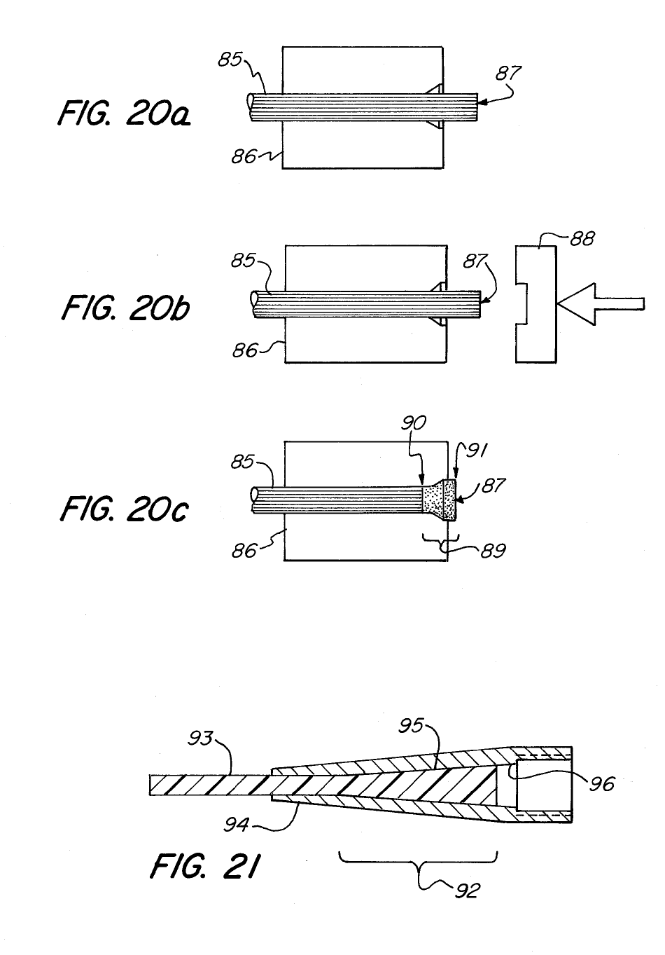

FIG. 20a illustrates an alternative embodiment of the invention where tension member 85 is placed into a die 86, such that the region of tension member 85 closest to tension member end 87 is within the die 86, and a portion of tension member end 87 protrudes from die 86. In FIG. 20b, a second die 88 is applied to tension member end 87 and die 86 from the direction of tension member end 87, and heat and pressure are applied to the arrangement such that a shaped terminal is formed, having a consolidated and substantially uniform composition. Second die 88 can be rotated axially with respect to tension member end 87 during forming. This can have the advantage of inducing a desired order to the fiber orientation. FIG. 20c illustrates the arrangement after the formation of shaped terminal 89. Shaped terminal 89 is consolidated such that its composition is unified in structure, and comprises an inner end 90 that is disposed toward the center of tension member 85, and an outer end 91 that is disposed toward, or coincident with, tension member end 87. Outer end 91 may have a dimension that is greater than a corresponding dimension of the inner end 90.

FIG. 21 illustrates an application of a shaped terminal 92 that has been formed according to the invention where the tension member 93 is connected to a fitting 94 or other attachment. The connection between tension member 93 and fitting 94 is effected by the geometries of the exterior surface 95 of the shaped terminal 92 and the interior surface 96 of the fitting 94 or other attachment. These geometries can be arbitrarily optimized to locate the distribution of forces to desired portions of shaped terminal 92 and/or fitting 94. In the example arrangement of FIG. 21, tension member 93 is held fast within fitting 94 when they are in tension. Because of the solid and uniform structure of the terminal, the tension member is advantageously able to resist pull-through and individual stresses upon the component fibers at the fitting. In an alternative arrangement, tension member 93 could be adapted to be held within fitting 94 in the absence of tension by the addition of a stopper (not shown). Alternatively, the geometries of exterior surface 95 and interior surface 96 could be formed with complementary threaded, notched, grooved, frictional, or other similarly functioning surface features (not shown).

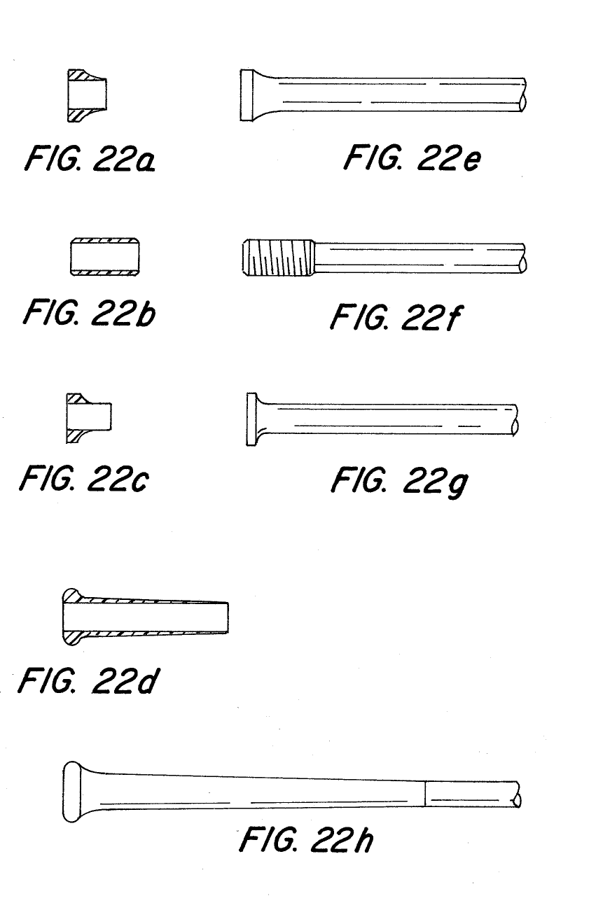

FIGS. 22a-h illustrate various example geometries into which consolidated shaped terminals may be formed using the methods described above, and corresponding collar shapes which may be used in order to create these geometries according to alternative embodiments of the invention as described above. These shaped terminal geometries (FIGS. 22e-h), which comprise various heads and threaded ends, may be applied as a pre-formed collar pieces (FIGS. 22a-d) using the methods described and shown with respect to FIGS. 17 and 18, may be formed by conforming the exterior surface of the shaped terminal to a suitably shaped interior surface (not shown) of a die (not shown) using the methods described and shown with respect to FIG. 4, or a combination of any or all of the methods described herein.

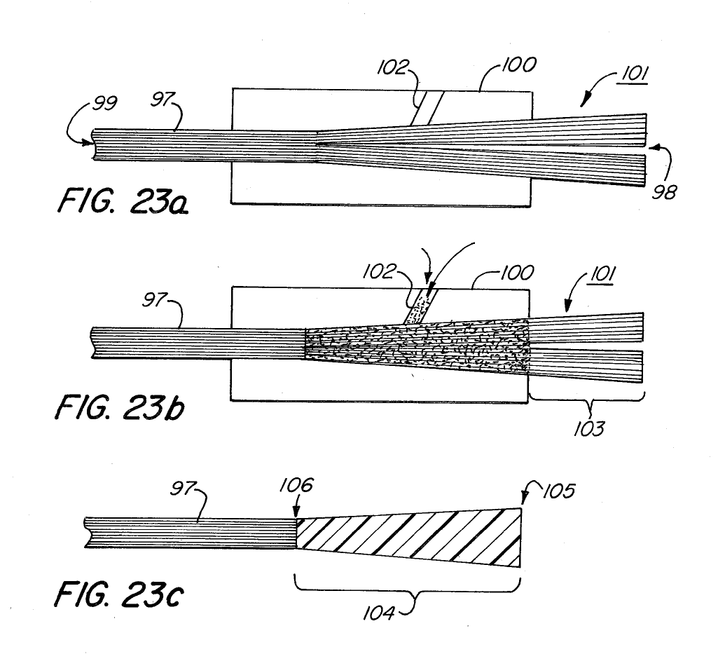

FIGS. 23a-c illustrates an alternative embodiment of the invention which includes adding material to the tension member end prior to consolidation. This embodiment is similar to the preferred embodiment described above with respect to FIG. 4, except in that the addition of composite or thermoplastic material to the end of a tension member is achieved during the initial consolidation rather than by using the drilling, splitting, and filling steps of the preferred embodiment that are described with respect to FIG. 4 (12, 13, 14). This arrangement, or any portions of this arrangement, may be used in combination with any of the embodiments described herein to replace or compliment steps for adding material to the tension member end.

FIG. 23a illustrates an arrangement where a plurality of composite rods, fibers, tow or tape are first arranged to form a bundle 97 having a first end 98 and a second end 99. First end 98 is placed within a die 100, and the component materials forming the bundle 97 within the die 100 are arranged in a suitable pattern such as a distributed, conical, or other pattern, such that interstitial spaces exist within the first end 98. The materials may be arranged by feeding them through a disk with a suitable arrangement of holes, a loom, or another suitable method (not shown). Bundle 97 is then tensioned such that its individual components are under equal tension. The tensioning may be achieved through the application of weights to the individual components, or by another suitable method (not shown). A channel 102 is disposed within die 100 such that materials (not shown), which may comprise composites, thermoplastic resins, or other materials, may be added to the interstitial spaces within first end 98.

FIG. 23b, illustrates the arrangement where materials have been added to the interstitial spaces within the first end 98 via channel 102. First end 98 is consolidated by applying heat and pressure to while it is within the die 100 to create a consolidated end comprising a unified structure. Surplus end materials 103 which protrude from the die may subsequently be sliced or removed in a suitable manner from the first end 98 in order to form a shaped terminal (not shown) that is consolidated and substantially uniform in structure.

FIG. 23c illustrates the resulting consolidated shaped terminal 104 formed as described regarding FIGS. 23a-b. Shaped terminal 104 is consolidated and substantially uniform in structure, and has an outer end 105 disposed toward, or substantially coincident with, the end of the tension member; an inner end 106 disposed toward the center of the tension member; and where the outer end 105 of the shaped terminal 104 has a dimension that is greater than a corresponding dimension of the inner end 106 of the shaped terminal 104.

What is claimed is:

1. A tension member comprising:
a plurality of resin/fiber composite rods, fibers, tow, or tape arranged as a bundle having a first end and a second end;
at least one of the first end and the second end having the form of a consolidated shaped terminal;
the consolidated shaped terminal being substantially uniform and solid in structure, and having an inner end and an outer end;
the outer end having a dimension greater than a dimension of the inner end.

2. The tension member of claim 1, wherein the consolidated shaped terminal has a geometry that is a frustum, a concave head, a convex spherical head, a conical taper, an eye, threaded, or an overlap joint, unidirectional tube overlap joint, laminate, flatten and overlap, two-into-one butt-joint, or diagonal-into-vertical joint.

3. The tension member of claim 2, wherein the consolidated shaped terminal geometry is compatible with a fitting.

4. The tension member of claim 1, wherein the tension member is joined to a second tension member at one of the first end and the second end, and where the end is consolidated with a corresponding end of the second tension member to form an extended tension member.

5. The tension member of claim 1, wherein the tension member is joined to a second tension member at one of the first end and the second end, and where the end is consolidated with a corresponding central section of the second tension member to form a branched tension member.

6. The tension member of claim 1, wherein the tension member comprises at least one consolidated central portion.

7. The tension member of claim 6, wherein at least one consolidated central portion is radiused such that the tension member describes a bent shape.

8. A method of creating a consolidated shaped terminal to a composite tension member comprising:
providing a plurality of resin/fiber composite rods, fibers, tow or tape arranged to form a bundle having a first end and a second end;
adding additional thermoplastic or composite material to at least one of the first end and the second end to form a consolidated shaped terminal; such that
the consolidated shaped terminal is substantially uniform and solid in structure, and has an inner end and an outer end where a dimension of the outer end is greater than a dimension of the inner end.

9. The method of claim 8, wherein the consolidated shaped terminal is formed by
placing at least one of the first end and the second end into a die, or wrapping at least one of the first end and the second end with heat-shrink tape; and,
applying heat and/or pressure.

10. The method of claim 9, wherein the first end or the second end is initially consolidated to form a consolidated end by
inserting it into a die or wrapping it with heat-shrink tape, and
applying heat and/or pressure.

11. The method of claim 10, wherein the addition of thermoplastic or composite material is achieved by:
drilling the consolidated end axially;
splitting the drilled consolidated end axially; and,
incorporating the additional thermoplastic material into the void that was created by drilling and splitting.

12. The method of claim 10, wherein the addition of thermoplastic or composite material is achieved by:
plunging a spiked plunger axially into the consolidated end while it is within a die;
removing the spiked plunger and incorporating the additional thermoplastic material into the void created by removing the spiked plunger.

13. The method of claim 10, wherein the addition of thermoplastic or composite material is achieved by:
plunging a spike axially into the consolidated end while it is within a die,
where the spike is comprised of thermoplastic or composite material and is incorporated into the consolidated shaped terminal by applying heat and pressure.

14. The method of claim 10, wherein
a spike is plunged axially into the consolidated end while it is within a die,
where the spike is comprised of a metal or metal alloy and is incorporated into the consolidated shaped terminal by applying heat and pressure.

15. The method of claim 10, wherein the addition of thermoplastic or composite material is achieved by:
inserting the consolidated end into a shaped sleeve that is comprised of thermoplastic or composite material; and
incorporating the shaped sleeve into the consolidated shaped terminal by applying heat and pressure.

16. The method of claim 8, wherein the tension member is joined to a second tension member at one of the first end and the second end by consolidating the end with a corresponding end of the second tension member to form an extended tension member.

17. The method of claim 8, wherein the tension member is joined to a second tension member at one of the first end and the second end by consolidating the end with a corresponding consolidated central section of the second tension member to form a branched tension member.

18. The method of claim 8, wherein at least one central portion of the tension member is consolidated.

19. The method of claim 8, wherein at least one central portion is consolidated to form radiused shape such that the tension member describes a bent shape.

20. The method of claim 8, wherein at least one central portion is compressed and reformed such that an exterior profile of the bundle is given a smaller cross-section and/or a desired shape, and such that at least some interstitial spaces between the resin/fiber composite rods, fibers, tow or tape are removed or reduced.

21. The method of claim 8, wherein central portions of the tension member are consolidated using a transportable die, which in operation surrounds the bundle and is disposed such that it can apply heat and pressure to the tension member.

22. The method of claim 21 wherein the transportable die can be transported along the length of the tension member such that it can be used to apply heat and pressure to various sections of the tension member.

23. The method of claim 22 wherein the transportable die can be used to apply heat and pressure continuously to the tension member during transport along the length of the bundle to form continuous consolidated sections.

24. The method of claim 23 wherein the transportable die is disposed such that it can be rotated axially around the bundle during transport along the length of the bundle.

25. A method of creating a shaped terminal to a composite tension member comprising:
providing a plurality of composite rods, fibers, tow or tape arranged to form a bundle having a first end and a second end;
consolidating at least one of the first end and the second end to form a consolidated end by
placing the first end or the second end into a die; and,
applying heat and pressure to the end while it is within the die to create a consolidated end that is homogeneous in structure;
drilling the consolidated end axially to create a drilled consolidated end;
splitting the drilled consolidated end axially to create a split end having one or more axial splits;
filling the split consolidated end to create a filled end by
adding thermoplastic and/or composite material to the void that was created by drilling and splitting;
consolidating the filled end to create a shaped terminal by
placing the filled end into a die; and,
applying heat and pressure to the end while it is within the die to create a shaped terminal that is consolidated and substantially uniform in structure, and where the shaped terminal has
an outer end disposed toward or coincident with the end of the tension member;
an inner end disposed toward the center of the tension member; and
where the outer end of the shaped terminal has a dimension that is greater than a corresponding dimension of the inner end of the shaped terminal.

26. The method of claim 25, wherein consolidating at least one of the first end and the second end to form the consolidated end entails first wrapping the first end or the second end with heat-shrink tape prior to placement into the die.

27. The method of claim 25, wherein consolidating at least one of the first end and the second end to form the consolidated end entails
an initial pre-consolidation step wherein
the first end or the second end is first placed into a pre-consolidation die and compressed and reformed using heat and pressure such that an exterior profile of the bundle is given a smaller cross-section and/or a desired shape, and
such that at least some interstitial spaces between the resin/fiber composite rods, fibers, tow or tape are removed or reduced;
prior to placement into the die for consolidation.

28. The method of claim 25, wherein splitting the drilled consolidated end axially to create a split end having one or more axial splits is performed by:
indexing the tension member by a desired number of degrees around its axis;
inserting the drilled consolidated end into a splitting die to form a split consolidated end, the splitting die having a blade disposed therein such that the blade will split the drilled consolidated end upon insertion;
removing the split consolidated end from the splitting die; and,
optionally, repeating the splitting a desired number of times.
